(19) United States
(12) Patent Application Publication
(10) Pub. No.: US 2005/0128955 A1
(43) Pub. Date: Jun. 16, 2005

(54) Transmission system for network with communication quality indicating capability and the method of the same

(75) Inventors: Su-Yuan Chang, Taipei (TW); Yin-Ju Chen, TaoYuan (TW); Wei-Chiang Peng, ChungLi City (TW); Jian-Zhi Liao, TaiChung (TW); Chieh-Chan Hsu, Hsinchu (TW); Wan-Wan Shen, ChungLi City (TW); Yi-Der Lin, TaiNan (TW); Jiun-Jyi Chen, KaoHsiung (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 10/781,738

(22) Filed: Feb. 20, 2004

(30) Foreign Application Priority Data
Dec. 16, 2003 (TW) 92135481

(51) Int. Cl. H04L 12/26

(52) U.S. Cl. 370/252

(57) ABSTRACT

A transmission system for network with communication quality indicating capability and the method of the same, which is capable of providing real-time communication quality and display thereof at a station of the system.

### 1. FIELD OF THE INVENTION

The present invention relates to a transmission system for network with communication quality indicating capability and the method of the same, more particularly to a method for detecting and indicating the communication quality and a network transmission system of a Voice over Internet Protocol (VoIP).

### 2. BACKGROUND OF THE INVENTION

With rapid development of network technology and advancement of IP (Internet Protocol) telephony, the traditional circuit switch PSTN (public switched telephone network) environment and the Internet that originally belong to different networks are merged together for a common application, such as a Voice over Internet Protocol (VoIP). Please refer to FIG. 1, which is a schematic diagram of a conventional VoIP system. As seen, a VoIP phone 22 (which could be a hardphone 22a, a computer 22b, or a personal digital assistant 22c) communicates with other IP phones by transmitting audio data via Internet, wherein a gateway 20 is acting as a conversion interface between a PSTN 21 and Internet for converting an analog audio signal into a digital signal such that the VoIP phone 22 can communicate with traditional phone via the conversion of the gateway 20.

Since the VoIP service carries a communication cost far lower than that of traditional telephones and is able to integrate voice and data services, more and more companies had adopted the VoIP system for the application on their internal communication with oversea branches. In general, Users of VoIP system have the convenience in accessing voice, data, and even video services through a single piece of equipment, namely an IP platform, such that not only the management of the company adopting the same can be simplified, but also the cost can be reduced greatly. Traditional telephones use PSTN to transmit voice, and VoIP system encode/decode voice data into data packets that are transmitted over an IP network to a remote receiving end. The compressed voice data can be transmitted together with data in other forms via Internet. One voice channel of the traditional telephones requires 64Kbps, which is 10 times of that for VoIP system, and is not capable of sharing the same channel with other data for transmission. Besides, the voice data transmitted using VoIP service is compressed. Thus, the communication quality is closely related to the voice coding/decoding technology in a way that the higher the compression ratio, the narrower is the bandwidth required and the worse is the communication quality. In addition to the compression ratio of voice data, the loss and delay of voice packets also affect the quality of communication. The loss of packets is generally related to the design of algorithm for VoIP service, such as the packet assembly, the transmission method, and encryption/decryption speed, etc. The VoIP system transmits voice via Internet that the bandwidth of the system is closely related to the transmission quality. If a call is placed at peak hours, poor communication quality can be expected due to the network traffic jam. Along with the popularity and mature of the VoIP services, users have high demands on the quality of the VoIP services. The present invention aims at to a method and apparatus for detecting and indicating the communication quality since most prior studies are related to improve the communication quality. The PCT Patent No. WO 03/036889 A1 entitled “COMMUNICATION SESSION QUALITY INDICATOR” taught a method and apparatus for informing users about the current communication quality. When an end-to-end communication is proceeding between a first station and a second station, the Real-Time Transport Control Protocol (RTCP) provides the related communication quality to the user of the second station, but the communication quality provided by the RTCP is the communication quality of the first station which is not the communication quality of the second station, thus, an error might be incurred. In addition, not all communication devices support the RTCP. Therefore, the present invention provides a transmission system for network with communication quality indicating capability and the method of the same for detecting and indicating the communication quality of the second station in real time without any additional requirement of retrieving information from the RTCP. When the communication quality is bad, users may choose to make the call later and the communication service providers may voluntarily waive the charge or give a discount.

### SUMMARY OF THE INVENTION

The primary objective of the present invention is to provide a transmission system for network with communication quality indicating capability and the method of the same for detecting and indicating the communication quality, so that users can learn about the current communication quality of the network.

To achieve the foregoing objective, the method of the present invention is applied to a network transmission system having least has a first station and a second station. The method comprises the steps of: determining the communication quality of the network transmission system at the second station according to the data transmitted from the first station; and indicating the communication quality at the second station.

The transmission system for network with communication quality indicating capability according to the present invention comprises: a first station, a second station, a detecting unit, and an indicating unit. The first station sends out a data via a network, and the second station receives the data via the network. The detecting unit is disposed at the second station for detecting the data receiving condition in real time and computing the communication quality according to the same. The indicating unit is coupled to the detecting unit for indicating the communication quality at the second station.

Following drawings are cooperated to describe the detailed structure and its connective relationship according to the invention for facilitating your esteemed members of reviewing committee in understanding the characteristics and the objectives of the invention.

### BRIEF DESCRIPTION OF THE DRAWINGS

FIG. 1 is a schematic diagram of a conventional Voice over Internet Protocol (VoIP) phone.

FIG. 2 is a transmission system for network with communication quality indicating capability according to a preferred embodiment of the present invention.

FIG. 3 is a flow chart showing the method of indicating communication quality according to the present invention.

### DESCRIPTION OF THE PREFERRED EMBODIMENT

The present invention provides a transmission system for network with communication quality indicating capability and the method of the same for detecting and indicating the communication quality of VoIP phone, and provides a visual (or a audio) notification of the quality of the communication session at the time when the network is jammed or has poor communication quality, such that users can choose to make the call later or can understand the current poor communication quality is due to the poor network environment instead of other causes. Moreover, the communication service providers may voluntarily waive the charge or give a discount using the related information of the communication quality as a reference for charging the VoIP phone calls

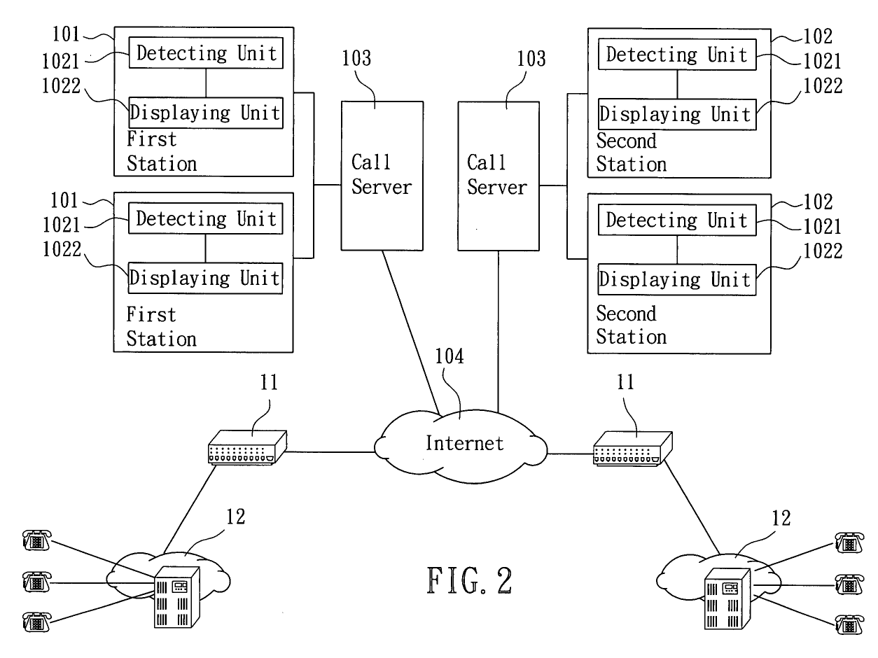

Please refer to FIG. 2, which is a transmission system for network with communication quality indicating capability according to a preferred embodiment of the present invention. The network transmission system is a voice over Internet protocol (VoIP) system, comprising a first station 101, a second station 102, a detecting unit 1021, and an indicating unit 1022. In this preferred embodiment, the VoIP communication protocol could be any one of the SIP, MEGACO, H323, MGCP, and SGCP, etc. The first station 101 and the second station 102 respectively could be one of the following: a computer, a communication program, and a VoIP phone. The detecting unit 1021 is disposed within the second station 102, and the indicating unit 1022 coupled to the detecting unit 1021 could be a liquid crystal display (LCD), a computer monitor, or a voice device. When a user at the first station 101 wants to talk to a user at the second station 102, the first station will digitize and compress the analog voice signal using the compression method, such as G.711, G.723.1, and G.729, etc., for creating the corresponding compressed voice data, and then the compressed voice data is packeted and sent to the second station 102 via the Internet 104 so as to achieve a real-time end-to-end communication between two stations 101, 102. In the VoIP system, after establishing a VoIP session between the first station 101 and the second station 102, the second station 102 will be informed of the amount of the packets (which is referred as a first packet number hereinafter) according to the current compression format used, and the detecting unit 1021 detects the actual amount of the received packets of the second station 102 (which is referred as a second packet number hereinafter). The first packet number is compared with the second packet number for computing the amount of missing packets such that the current transmission quality of the network can be evaluated. The indicating unit 1022 then can display the evaluation on the second station 102 using a symbol, a number, or other visually recognizable methods. Alternatively, a pre-recorded voice is used for informing a user at the second station 102 of the current communication quality by listening to the recorded voice. Further, a predetermined threshold can be set in the detecting unit 1021, so that when the the communication quality of the Internet 104 falls below the threshold, the indicating unit 1022 will remind the user with audio or visual indication. If the second station 102 is a computer, then a pop-up menu will appear to remind the user about the poor communication quality. On the other hand, a detecting unit 1021 and an indicating unit 1022 also can be disposed at the first station 101, such that the user at the first station 101 can learn about the current transmission quality of the network 104 by the aforementioned method, and thus will not be described here.

In this preferred embodiment of the present invention, the VoIP phone system further comprises a call server 103, connected to the second station 102, which is capable of automatically stopping the communication session between the first station 101 and the second station 102, and recording the communication quality between the two stations 101, 102 so as to provide the recording as a reference to the communication service providers for charging consideration, that is, when the communication quality is poor due to the traffic jam of the network 104, the communication service providers may give a discount or waive the charge. Four possible scenarios exist with the placement of a VoIP call: (1) PC-to-PC, (2) PC-to-phone, (3), phone-to-PC, and (4) phone-to-phone.

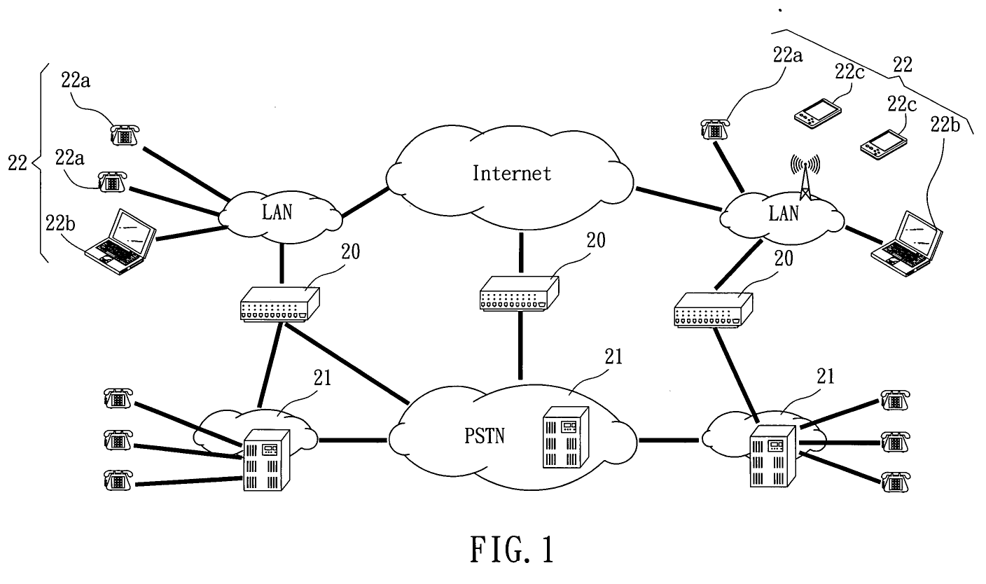

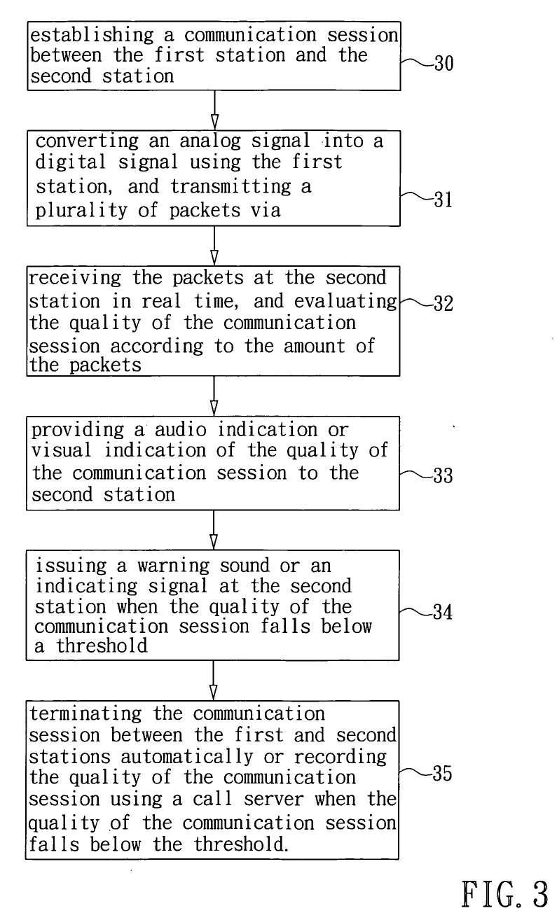

Please refer to FIG. 3, which is a flow chart showing the method of indicating communication quality according to the present invention. The method can be applied to the network communication system of FIG. 1. Although the preferred embodiment of the present invention adopts a VoIP phone, the aforementioned description is only the preferable embodiments according to the invention and can not be applied as a limitation to the field of the invention, and any equivalent variation and modification made according to the claims, such as fax over IP and video/data over IP, etc., are still within the spirits and the ranges of the invention. The method comprises the steps of:
Step 30: establishing a communication session between the first station 101 and the second station 102;
Step 31: converting an analog signal into a digital signal using the first station 101, and transmitting a plurality of packets via Internet 104, wherein the digital signal is compressed using a compression format selected from the following: G.711, G.723.1, and G.729, etc.;
Step 32: receiving the packets at the second station 102 in real time, and evaluating the quality of the communication session according to the amount of the packets, wherein the second station 102 will obtain the number of packets expected according to the compression format used by the first station 101 and the second station 102 while establishing the communication session;
Step 33: providing a audio indication or visual indication of the quality of the communication session to the second station 102 so that the user at the second station 102 cab learn about the current communication quality;
Step 34: issuing a warning sound or an indicating signal at the second station 102 when the quality of the communication session falls below a threshold;
Step 35: terminating the communication session between the first and second stations automatically or recording the quality of the communication session using a call server when the quality of the communication session falls below the threshold.

However, the aforementioned description is only the preferable embodiments according to the invention and, of course, can not be applied as a limitation to the field of the invention, and any equivalent variation and modification made according to the claims claimed thereinafter still possess the merits of the invention and are still within the spirits and the ranges of the invention, so they should be deemed as a further executing situation of the invention.

1. A method capable of indicating a communication quality and being used in a network transmission system having at least a first station and a second station, comprising the steps of:
determining the communication quality of the network transmission system according to a data transmitted from the first station to the second station; and
indicating the communication quality at the second station.

2. The method of claim 1, wherein the communication quality is indicated at the second station using a video signal.

3. The method of claim 1, wherein the communication quality is indicated at the second station using an audio signal.

4. The method of claim 1 further comprising a step of:
issuing a signal to inform users if the communication quality falls below a threshold.

5. The method of claim 1, wherein the network transmission system further comprises a server capable of interrupting a data transmission between the first and second stations basing on the communication quality.

6. The method of claim 5, wherein the server is capable of recording the communication quality for future reference and inquiry.

7. The method of claim 1, wherein the data comprises a plurality of packets enabling the second station to be able to evaluate the communication quality between the first and second stations according to the amount of the packets.

8. A transmission system for network with communication quality indicating capability, comprising:
a first station, transmitting a data via a network;
a second station, receiving the data from the network;
a detecting unit, disposed at the second station for detecting a data receiving condition in real time, and computing a communication according to the same; and
an indicating unit, coupled to the detecting unit for indicating the communication quality at the second station.

9. The network transmission system of claim 8, wherein the communication quality is indicated at the second station using a video signal.

10. The network transmission system of claim 8, wherein the communication quality is indicated at the second station using an audio signal.

11. The network transmission system of claim 8, wherein the network transmission system further comprises a server capable of interrupting a data transmission between the first and second stations basing on the communication quality.

12. The network transmission system of claim 11, wherein the server is capable of recording the communication quality for future reference and inquiry.

13. The network transmission system of claim 11, wherein the detecting unit issues a signal to inform users if the communication quality falls below a threshold.

14. The network transmission system of claim 11, wherein the data comprises a plurality of packets enabling the detecting unit to be able to compute the communication quality between the first and second stations according to the amount of the packets.
